(19) United States
(12) Patent Application Publication
(10) Pub. No.: US 2005/0033622 A1
(43) Pub. Date: Feb. 10, 2005

(54) Meeting management system

(76) Inventors: Jacky Kuo, Sindian City (TW); Albert Chang, Taichung City (TW); K. P. Lee, Taichung (TW); Konrad Young, Taipei (TW); S. S. Lin, Chushan (TW); David Lai, Taipei (TW)

Correspondence Address: DUANE MORRIS, LLP;IP DEPARTMENT, ONE LIBERTY PLACE, PHILADELPHIA, PA, 19103-7396, US

(21) Appl. No.: 10/636,439

(22) Filed: Aug. 6, 2003

(51) Int. Cl. G06F 17/60

(52) U.S. Cl. 705/8

(57) ABSTRACT

A computer implemented method uses a system (100) for managing meetings. The system (100) has, a database (104) with data fields for entering a meeting definition of a future meeting as meeting definition data; a computer memory (106) storing the data for retrieval by the database (104); and an auto-mailer (108) sending an encrypted and read only meeting definition document and meeting reminders that are generated by the database (104) and sent by the auto-mailer (108) to notify meeting members identified by the data about a future meeting described by the data.

### FIELD OF THE INVENTION

The present invention relates to a computer implemented method and system for managing meetings and for recording the progress of actions requested of meeting members.

### BACKGROUND

Electronic calendars have been implemented on a network of computers to schedule meetings among calendar owners. U.S. Pat. No. 4,819,191 discloses an electronic calendar having electronically triggered reminders of meeting events. The reminders are routed to all calendar owners to remind them of future meeting events.

A meeting management system and method is needed to manage meetings among members of a workplace. Meeting member must be notified of the meetings, and to receive reminders of the meetings. At a workplace, meetings are held among meeting members to contribute to a project or to solve problems. Meeting minutes are recorded and can be sent to meeting members via a mailing system. The meeting notifications and reminders and meeting minutes require extensive management activities. Management of the meetings and the meeting minutes requires more than an electronic calendar and a mailing system.

During a meeting, the meeting members may create action requests that contribute to the project or that contribute to problem solving. The action requests are requested to be performed by individuals. Subsequent meetings are held to record the progress of action requests, the completion of action requests, and the creation of new action requests. Thus, meeting minutes may include the creation of action requests, if any. Management of the action requests and their progress requires extensive management activities. A meeting management system and method is needed to record meeting minutes that may pertain to action requests and their progress toward completion.

Meeting members receive documents for meeting purposes, and for completing action requests. The documents need to be controlled against unauthorized disclosure of confidential information. Thus, authorization must be obtained for the documents to be read by meeting participants. A meeting management system is needed, which can organize such documents as read only documents, and can Of control authorization to view such read only documents.

### SUMMARY THE INVENTION

The present invention relates to a method and system for managing meetings. The system electronically records meeting information, and uses the meeting information to notify meeting members of meetings. Further, the system uses the meeting information to send reminders of the meetings via a security controlled electronic mailing system. The reminders are automatically generated to improve meeting communication and to improve readiness for the meetings. At a workplace, meetings are held among meeting members to contribute to a project or to solve problems. Meeting minutes are recorded as part of updated meeting information, and is be sent to meeting members via an electronic mailing system. The invention provides a process based meeting execution process to standardize meeting review methodology.

According to an embodiment of the present invention, a method and system for managing meetings controls access to documents that must be read by meeting members, and attaches read only documents as attachments to meeting minutes that are sent to meeting members via an electronic mailing system. The attachments are electronically attached to the “Attachment” data field, and are electronically attached to a meeting definition electronic document that is sent to meeting members.

According to another embodiment of the present invention, a method and system manages action requests that are requested of meeting members. The action requests are included with meeting minutes that are sent to meeting members via an electronic mailing system. The system according to the invention generates reminders of the action requests to improve the meeting process.

Embodiments of the invention will be disclosed by way of example with reference to the accompanying drawings.

### DRAWINGS

FIG. 1 is a view of a computer implemented, meeting definition system for managing meetings.

FIG. 2A is a view of a meeting definition interface.

FIG. 2B is a view of a meeting reminder interface.

FIG. 3 is a view of an auto-mailing interface of a system for managing meetings.

FIG. 4 is a view of a meeting minutes interface.

FIG. 5 is a flow chart of a method for managing meetings.

### DETAILED DESCRIPTION

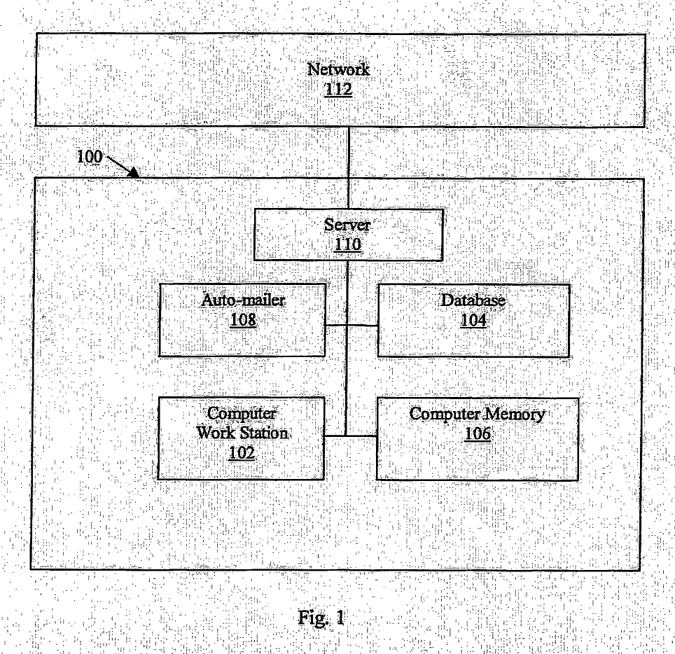

FIG. 1 discloses a system (100) for managing meetings. The system (100) has a computer work station (102) and a database (104) with data fields for entering a meeting definition of a future meeting as meeting definition data. The system (100) has a computer memory (106) storing the data for retrieval by the database (104), and an auto-mailer (108) sending an encrypted and read only meeting definition document and meeting reminders that are generated by the database (104) and sent by the auto-mailer (108) to notify meeting members identified by the data about a future meeting described by the data. In a distributed architecture the system (100) is connected by a server (110) to a company wide network (112). Alternatively, in an integrated architecture, the server (110) is absent, and the system (100) is part of the network (112).

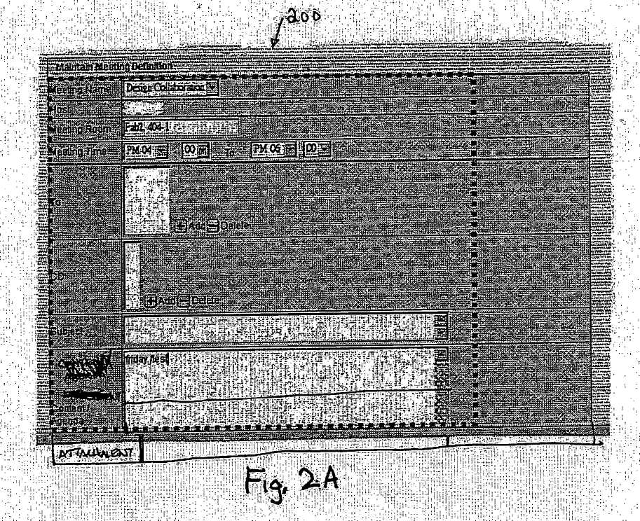

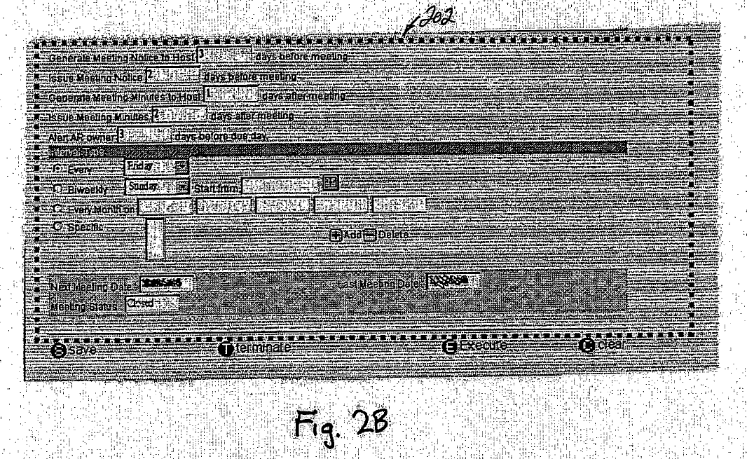

FIG. 2 discloses a meeting definition interface (200) generated by the database (102). For example, the meeting definition interface (200) is a graphical user interface, GUI, that is implemented by a computer work station (102) under the direction of a meeting host. The computer work station (102) uses the database (104) to generate the interface (200). A purpose of the meeting definition interface (200) is to describe a future meeting by meeting definition data entered in data fields that are present on the interface (200). The meeting definition interface (200) includes a “Host” data field identifying a meeting host. A meeting host is a person who organizes a meeting and subsequent meetings. The meeting host enters the correct data in the data fields of the meeting definition interface (200).

FIG. 2A discloses that the meeting definition interface (200) has further respective data fields, “meeting name” and “meeting date”. The meeting host enters data into these two data fields to identify a future meeting. These two data fields are stored by the database (104) as search queries. The database (104) retrieves the correct meeting definition data from storage in the memory (106), and into the data fields of the meeting definition interface (200).

FIG. 2A discloses that the meeting definition interface (200) has further respective data fields, “meeting room” or place for the meeting, “meeting time” and “meeting chairman” who is one of the meeting members. The meeting definition interface (200) has a further data field “To” that records the names of meeting members. The meeting definition interface (200) has a further data field “CC” that records persons to whom a copy of the meeting definition is routed for information purposes.

FIG. 2A discloses that the meeting definition interface (200) has a further data field “Content/Agenda” that records a description of the meeting purpose and a description of the meeting agenda. The meeting host enters agenda data in the “Content/Agenda” data field. For example the agenda data describes an agenda; to “Review” a problem with a manufacturing process, and to “Discuss” a procedure that could solve the problem, and to have an “Open Discussion”. After the meeting host has entered the correct data into the meeting definition interface (200), it is stored by the database (104) for retrieval by the meeting host using the data fields, “meeting name” and “meeting date” as search queries. The database (104) stores the data pertaining to many different meeting definitions. The data for each meeting definition is retrieved from storage in the memory (106), and is displayed on the meeting definition interface (200). Thus, for each meeting definition, no copies of it are made by the meeting host or by meeting members, which saves electronic storage capacity of the network. Further, stale versions of the meeting definition will not be kept by persons and referred to in error.

The database (104) generates an electronic meeting definition document containing information described by the meeting definition data that has been entered in the data fields on the meeting definition interface (200). The meeting definition document is encrypted, read only file type that is electronically sent to meeting members to inform them of a future meeting.

FIG. 2A further discloses that the meeting definition interface (200) has a data field “Attachment” that identifies electronic documents intended for reading by the meeting members. Although some meetings do not require documents, a future meeting may require the meeting members to view documents prior to the meeting. All such documents are sent to the meeting host prior to a meeting. The meeting host checks the top down reporting organization as the official security control of the authorization for meeting members to read the documents.

The security control uses security levels based on a top down reporting organization. For example, a top down reporting system may comprise team members directly reporting to supervisors of Sections. The supervisors of Sections report to managers of Departments. The managers of Departments report to managers of Divisions. The top down level of the meeting member in the reporting organization determines the security classification of the meeting member, who can view documents that are classified at the same security level and below. When a meeting member lacks authorization to view a document of higher security level, the meeting host must obtain official authorization for the meeting member to view the document of higher security level, before the document is attached to the “Attachment” data field.

After obtaining the official authorization, an encrypted, read only electronic document is created under direction of the meeting host. The database (104) of the system (100) stores the electronic documents relationally with the meeting definition data for which the documents are intended. Each encrypted, read only document is an electronic attachment in the data field “Attachment”. The attachments are part of the meeting definition data.

Thus, the meeting members have limited permission to access and read the electronic documents by viewing them as electronic attachments to the meeting definition document sent to them by electronic mail.

The meeting host has time before the date of a meeting to retrieve the meeting definition interface (200) with the correct data from the network, and attach the correct documents to the data field “Attachment”. Thus, the system (100) of the invention (1) for managing meetings avoids leaks of confidential information, by eliminating paper and electronic documents that are unattached. Unattached documents are under less dominion and control than the read only encrypted electronic attachments. The system (100) according to the invention solves the problems associated with information security and efficient information sharing by meeting members. The system (100) incorporates a security system to control information security and data sharing with high communication quality and efficiency.

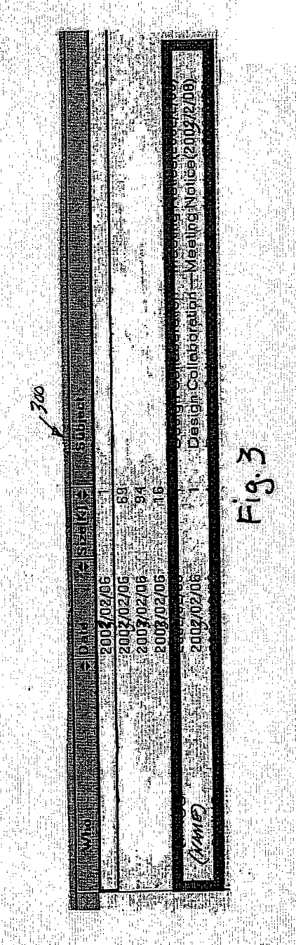

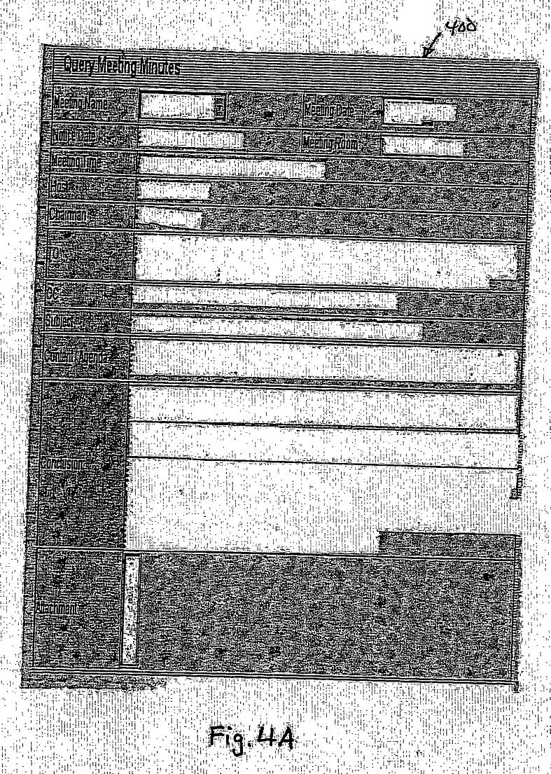

FIG. 3 discloses that the system (100) has a computer implemented auto-mailing interface (300) of the auto-mailer (108) that operates with the electronic mail system, i.e., internal e-mail system, on a workplace network. For example, the auto-mailing interface (300) is a graphical user interface, GUI, that is implemented by a computer work station (102) under the direction of the meeting host.

The auto-mailer (108) signals the database (104) to generate the meeting definition document. The auto-mailing interface (300) uses the data fields of the meeting definition interface (200) as e-mail addressees to send the meeting definition document to the e-mail addresses of meeting members, who include member's managers listed by the “CC” data field. The meeting definition document may have any suitable appearance as an encrypted, read only document generated by the database (104) using the data fields of the meeting definition.

The auto-mailing interface (300) has additional data fields. The meeting host enters correct data into the appropriate data fields. The auto-mailing interface (300) has a “To” data field for entering an addressee's e-mail address on the network. A “Date” data field indicates the correct date that is automatically generated. A “Size (K)” data field indicates an automatically generated volume in electronic kilobytes of the e-mail communication. The auto-mailing interface (300) has a “Subject” data field for the meting host to enter a brief description identifying the e-mail subject.

The meeting definition document is an electronic document of any suitable appearance, as generated by the database (104). The meeting definition document informs meeting members of a future meeting that is described by the meeting definition data that has been entered in the data fields of the meeting definition interface (200). The meeting definition document is generated and sent to meeting members as an encrypted, read only electronic e-mail document to prevent copying. The meeting definition document is encrypted with internal encryption format control. For example, the workplace network supplies public and private encryption/decryption keys to the meeting members, which allows them to decrypt the e-mail version of the read only, meeting definition document. Further, the meeting definition interface (200) can be altered solely by the meeting host identified in the data field “Meeting Host” using his/her decryption key. Since the read only meeting definition document is not copied, storage space in the computer memory (106) is saved, and the meeting definition has consistent, updated information. No stale copies can be found and referred to in error.

FIG. 2B discloses that the system (100) has a meeting reminder interface (202), which is generated by the database (104), and which remains with the meeting definition interface (200). For example, the meeting reminder interface (202) is a graphical user interface, GUI, that is implemented by a computer work station (102) under the direction of a meeting host. The meeting reminder interface (202) has multiple data fields. The meeting host enters correct data into the appropriate data fields. The purpose of the meeting reminder interface (202) is to generate and send electronic mail (internal e-mail) reminders of a meeting described by the meeting definition interface (200). The electronic reminders are generated by the database (104), and are sent via the auto-mailing interface (300).

The meeting reminder interface (202) has a data field “Generate Meeting Notice to Host [?] days before meeting”. The meeting host enters a desired number of days that are adjustable as a meeting reminder. For example, “3” days are shown. The meeting reminder interface (400) has a data field “Issue Meeting Notice” [?] days before meeting”. The meeting host enters a desired number of days that are adjustable as a meeting reminder. For example, “2” days are shown.

The meeting reminder data is stored in the memory storage of the auto-mailer (108) as the days when the auto-mailer (108) signals the database (104) to generate the reminders, and to send the meeting reminders. Meeting reminders are generated by the database (104) and sent via the auto-mailing interface (300) that uses the “To” data field as e-mail addresses of the meeting members, and uses the “CC” data field as e-mail addresses. Since the dates of all reminders are adjustable, the meeting host can choose to receive the meeting reminder earlier than the meeting members. Thus, the meeting host will have personal contact opportunities to visit the meeting members prior to them receiving their meeting reminders. The host can personally contact each meeting participant via the best available way.

The meeting reminder interface (202) has additional data fields under the title, “Internal Type”. An “Every” data field can be selected with a mouse click command. The “Every” data field has choices in a pull-down menu to enter in the “Every” data field. For example, “Friday” is shown as a choice. A “Biweekly” data field can be selected with a mouse click command. The “Biweekly” data field has choices in a pull-down menu to enter in the “Biweekly” data field. For example, “Sunday” is shown as a choice. An “Every Month on” data field can be selected with a mouse click command. The “Every Month on” data field has five data field windows in which to enter choices. A “Specific” data field can be selected with a mouse click command. The “Every Month on” data field has one window to enter a choice. A “Next Meeting Date” window displays the date for the next future meeting. A “Last Meeting Date” window displays the date of a last previous meeting.

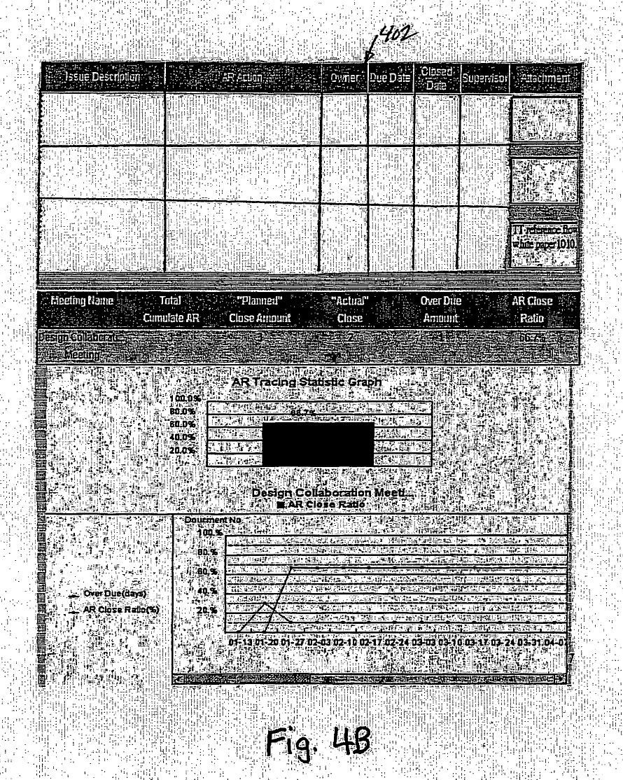

During a meeting, a portable computer work station (102) under direction of the meeting host is connected to the network to retrieve a meeting minutes interface (400) disclosed by FIG. 4A. The meeting minutes interface (400) has all the data and all the data fields of the meeting definition interface (200). The agenda in the “Content/Agenda” data field organizes the meeting conducted by the meeting members and the meeting host. Meeting minutes are kept and entered as new updated data in the “Conclusion” data field of the meeting minutes interface (400). The meeting minutes become part of a new meeting definition for another future meeting. FIG. 2 further discloses a data field “Conclusion” that records the meeting minutes that become part of the meeting definition data for another future meeting.

FIG. 4B discloses that the meeting has an AR List & Progress Report interface (402) as part of the meeting minutes interface (400). During a meeting, the meeting members by consensus decide upon a description of issues in the form of problems to solve. A description of each issue is entered as data in a data field “Issue Description” on the AR List & Progress Report interface (402). The meeting members act in consensus and create action requests, ARs, that contribute to problem solving. The action requests are requested to be performed by individuals. An AR definition of each action request is entered as data in a data field “AR Action” on the AR List & Progress Report interface (402). The AR owner of an action request is entered as data in a data field “Owner” on the AR List & Progress Report interface (402). A due date for completing the action request is entered as data in a “Due Date” data field of the AR List & Progress Report interface (402). The AR management process is communicated to all meeting members to create a common consensus about the AR definition and its performance or execution. Further, communication gaps are reduced, and delayed AR execution is reduced. The system (100) reduces the inquiries for meeting information clarification.

When the AR owner needs to read documents that assist in performance of an action request, the documents are attached in the “Attachment” data fields that are relationally associated by the database (104) solely with the AR owner that needs to view the documents.

All such documents are sent to the meeting host prior to a meeting. The meeting host obtains official authorization, according to the procedure described above. Encrypted, read only electronic documents are created under direction of the meeting host. The system (100) according to the invention has data fields in the database (104) for storing electronic documents that are electronically attached as encrypted, read only documents in the respective “Attachment” data fields that are relationally associated with the AR owner who has a need to view the attachments. The AR owners each have their own respective “Attachment” data fields on the AR List & Progress Report interface (402). Thus, the respective AR owners have access solely to the attachments entered in their own “Attachment” data field. The AR owners view their electronic attachments that are attached to the meeting definition document that is modified with the attachments solely for the respective AR owners. The attachments are part of the meeting definition data that is restricted for respective AR owners.

The meeting host has time before the next meeting to retrieve the meeting minutes interface (400) and the AR List & Progress Report interface (402) with the correct data, and attach the correct documents to the respective data fields “Attachment”. Thus, the system (100) of the invention (1) for managing meetings avoids leaks of confidential information, by eliminating paper and electronic documents that are unattached.

During each subsequent meeting, the action requests are reviewed, one by one, to record the progress of the action requests, the completion of action requests, and the creation of new action requests. When the meeting members have decided that an action request is completed, it is closed out, and the date is entered as data in a “Closed Date” data field of the AR List & Progress Report interface (402). The data in the data fields of the AR List & Progress Report interface (402) are part of the meeting definition data.

The AR List & Progress Report interface (402) has a data field “Supervisor” for entering the name of the AR owner's manager at the workplace. The manager names and the person names reporting to the managers are categorized according to a top down organization table in the database (104) and retrieved from computer memory (106) by the auto-mailer (108) for entry in the data field “Supervisor”. When the data field “Due Date” indicates that an AR is overdue for the first time, an e-mail reminder is generated automatically by the database (104). The reminder is sent via the auto-mailing interface (300) to the “AR Owner” and the direct manager or “Supervisor” named in the data fields, “AR Owner” and “Supervisor”.

The AR List & Progress Report interface (402) has the data fields, “Meeting Name” and “Total; Cumulate AR” and “‘Planned’ Close Amount” and “‘Actual’ Close Amount” and “‘Overdue’ Amount” and “AR Close Ratio”. The database (104) generates a graph named “AR Tracing Statistic Graph” that indicates the AR close ratio, i.e., [Closed ARs: Total ARs] in a bar graph format. The database (104) generates another graph indicating a line graph of the AR close ratio and a line graph of the Over Due Days for overdue ARs. Thus, meeting efficiency measurement data is stored and graphically presented by the database (104).

The meeting reminder interface (202) has a data field “Generate meeting minutes to Host” [?] days after meeting”. The meeting host enters a desired number of days that are adjustable. For example, “1” day is shown. The purpose of this data field is to schedule when to generate a correct meeting definition document that includes the meeting minutes created from data in the data fields of the meeting minutes interface (400) and send it to the correct meeting host via the auto-mailing interface (300). Both the first meeting definition document and each subsequent meeting definition document including the meeting minutes is scheduled, generated and sent. The meeting host checks for correctness of an initial agenda or a revised agenda in the “Content/Agenda” data field, and checks for correctness of the meeting minutes recorded as data in the data field “Conclusion” of the meeting minutes interface (400), and checks for encrypted, read only documents in the respective “Attachment” data fields. The “Content/Agenda” data becomes part of the meeting definition data. The attachments become encrypted and read only documents that are electronic attachments of the meeting definition document.

The meeting reminder interface (202) has a data field “Issue Meeting Minutes” [?] days after meeting”. The meeting host enters a desired number of days that are adjustable. For example, “2” days are shown. The purpose of this data field is to schedule when to generate the correct meeting definition document including the correct meeting minutes and send it via the auto-mailing interface (300) to the correct “Meeting Members” and the persons indicated on the “CC” data field.

The meeting reminder data is stored in the memory storage of the auto-mailer (108) as when the auto-mailer (108) signals the database (104) to generate the meeting definition document including the meeting minutes, and to send the meeting definition document. The meeting definition document including the meeting minutes is generated by the database (104) and sent via the auto-mailing interface (300) that uses the “To” data field as e-mail addresses of the meeting members, and uses the “CC” data field as e-mail addresses.

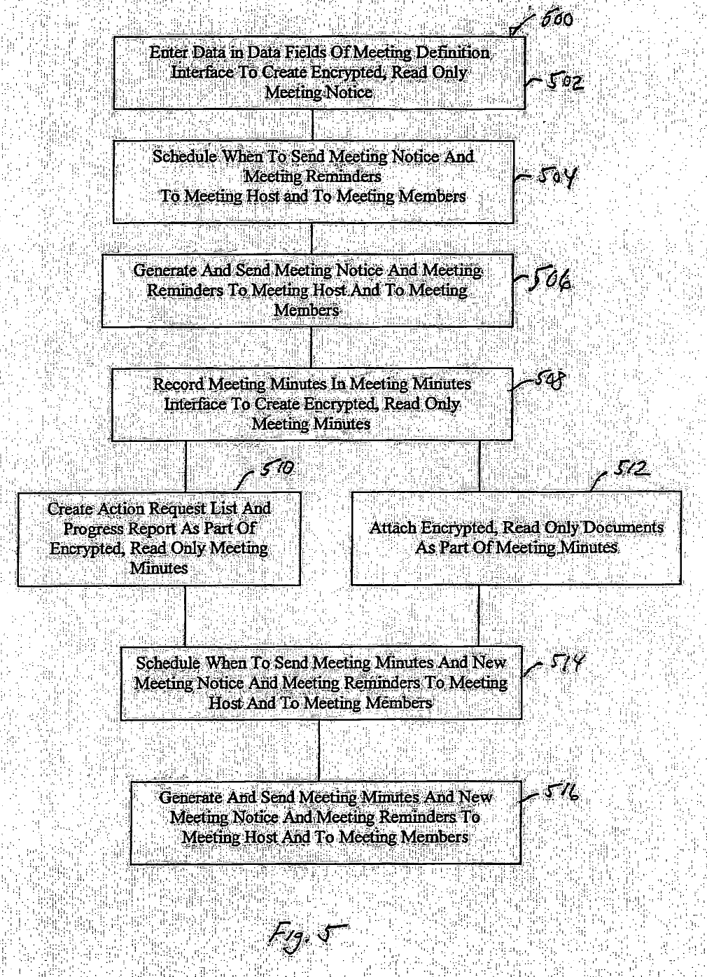

FIG. 5 discloses a method (500) for managing meetings, wherein method steps (502) (504) (506) and (508) are performed, in a manner as described in FIG. 5. Method step (510) is performed when a document would be attached as part of the meeting minutes described by method steps (508) and (510). Method steps (514) and (516) are performed, following method steps (510) and (512), in a manner as described by FIG. 5.

An embodiment of the invention has been described. Other embodiments and modifications thereof are intended to be covered by the spirit and scope of the appended claims.

1. A computer implemented method for managing meetings comprises the steps of:
entering a meeting definition of a future meeting as meeting definition data in data fields of a database;
generating and sending a meeting definition document notifying meeting members identified by the data about a future meeting described by the meeting definition data; and
generating and sending meeting reminders to the meeting members and to a meeting host identified by the meeting definition data.

2. A computer implemented method as in claim 1, and further comprising the step of:
generating the meeting definition document as an encrypted and read only electronic document for viewing by the meeting members.

3. A computer implemented method as in claim 1, and further comprising the steps of:
scheduling an adjusted date for sending a meeting reminder to the host; and
scheduling an adjusted date for sending meeting reminders to the meeting members.

4. A computer implemented method as in claim 1, and further comprising the steps of:
recording meeting efficiency measurement data in corresponding data fields of the database, and generating one or more graphs of the meeting efficiency data.

5. A computer implemented method as in claim 1, and further comprising the step of:
recording action requests and their due dates in respective data fields of the database as part of the meeting definition data.

6. A computer implemented method as in claim 1, and further comprising the step of:
entering encrypted, read only electronic attachments in an attachment data field of the database as part of the meeting definition data.

7. A computer implemented method as in claim 1, and further comprising the steps of:
recording action requests and their due dates as action request data in respective data fields of the database;
recording owners of the action requests as owner data in respective owner data fields of the database; and
including the action request data and the owner data in the meeting definition data.

8. A computer implemented method as in claim 1, and further comprising the steps of:
recording action request data and their due date data in respective data fields of the database;
recording respective owners of the action requests who are to view attachments as respective owner data in respective owner data fields of the of the database;
entering encrypted, read only electronic attachments intended for viewing solely by the respective owners as attachment data in respective attachment data fields of the database;
including the respective owner data as part of the meeting definition data; and
including the attachment data as part of the meeting definition data solely for the respective owners.

9. A computer implemented method as in claim 1, and further comprising the step of:
entering meeting minutes of a meeting as data in a respective data field of the database as part of the meeting definition data.

10. A computer implemented method as in claim 1, and further comprising the steps of:
scheduling an adjusted date for sending the meeting minutes to the meeting host; and
scheduling an adjusted date for sending the meeting definition document, including the meeting minutes, to the meeting members.

11. A computer implemented system for managing meetings comprising:
a database having data fields for entering a meeting definition of a future meeting as meeting definition data in the data fields;
a computer memory storing the data for retrieval by the database; and
an auto-mailer sending an encrypted and read only meeting definition document and meeting reminders that are generated by the database and that notify meeting members identified by the data about a future meeting described by the data.

12. A computer implemented system for managing meetings as in claim 11, and further comprising:
a meeting definition interface generated by the database, the interface having data fields for the meeting definition data.

13. A computer implemented system for managing meetings as in claim 11, and further comprising:
a data field in the meeting definition interface for attaching encrypted, read only attachments that are part of the meeting definition data.

14. A computer implemented system for managing meetings as in claim 11, and further comprising:
a meeting reminder interface scheduling when to generate and send a meeting definition document and when to generate and send a meeting reminder.

15. A computer implemented system for managing meetings as in claim 11, and further comprising:
action request data fields and due date data fields of the database recording action requests and their due dates as part of the meeting definition data.

16. A computer implemented system for managing meetings as in claim 11, and further comprising:
action request data fields and due date data fields of the database recording action requests and their due dates as part of the meeting definition data;
respective owner data fields of the database recording owners of the action requests as part of the meeting definition data.

17. A computer implemented system for managing meetings as in claim 11, and further comprising:
action request data fields and due date data fields of the database recording action requests and their due dates as part of the meeting definition data;
respective owner data fields of the of the database recording respective owners of the action requests who are to view attachments as part of the meeting definition data;
respective attachment data fields of the database recording encrypted, read only electronic attachments intended for viewing solely by the respective owners as part of the meeting definition data solely for the respective owners.

18. A computer implemented system for managing meetings as in claim 11, and further comprising:
a respective data field of the database entering meeting minutes of a meeting as part of the meeting definition data.

19. A computer implemented system for managing meetings as in claim 11, and further comprising:
a respective data field of the data base scheduling an adjusted date for sending the meeting minutes to the meeting host; and
a respective data field of the data base scheduling an adjusted date for sending the meeting definition document, including the meeting minutes, to the meeting members.

20. A computer implemented system for managing meetings as in claim 11, and further comprising:
corresponding data fields of the database recording meeting efficiency data for one or more graphs of the meeting efficiency data.
